(19) United States
(12) Patent Application Publication
(10) Pub. No.: US 2004/0096629 A1
(43) Pub. Date: May 20, 2004

(54) Vertically stacked carded aramid web useful in fire fighting clothing

(76) Inventors: Arun Pal Aneja, Greenville, NC (US); Laurence N. Bascom, Amelia, VA (US); Robert Lee Edmundson, Elm City, NC (US); Richard Hall Young, Richmond, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/299,307

(22) Filed: Nov. 19, 2002

(51) Int. Cl. B32B 3/28; B32B 3/30; B31F 1/00

(52) U.S. Cl. 428/182; 442/415; 19/98; 156/196; 156/227; 156/296

(57) ABSTRACT

A vertically stacked aramid set contains carded p-aramid and m-aramid fibers useful as an inner lining in fire fighting clothing.

### FIELD OF THE INVENTION

The present invention is directed to a vertically stacked carded aramid web which can be employed as an insulating thermal liner in fire fighting clothing.

### BACKGROUND OF THE INVENTION

Most turnout gear commonly used by firefighters in the United States comprise three layers, each performing a distinct function. There is an outer shell fabric often made from flame resistant aramid fiber such as poly(meta-phenylene isophthalamide)(MPD-I) or poly(para-phenylene terephthalamide)(PPD-T) or blends of those fibers with flame resistant fibers such as polybenzimidazoles (PBI). Adjacent to the outer shell fabric is a moisture barrier and common moisture barriers include a laminate of Crosstech® PTFE membrane on a woven MPD-I/PPD-T substrate. Adjacent the moisture barrier is an insulating thermal liner which generally comprises a batt of heat resistant fiber.

The outer shell serves as initial flame protection while the thermal liner and moisture barrier protect against heat stress.

U.S. Pat. No. 5,645,296 discloses flexible fire and heat resistant materials formed from an intimate mixture of organic intumescent filler and organic fibers.

U.S. Pat. No. 5,150,476 discloses a layered insulating fabric useful as a lining commonly worn by fire fighters which comprises an intermediate layer of pleated material wherein the pleats define between an array of air pockets that function as thermal insulation.

A need is present for an improved insulating material which can be employed as an inner lining in fire fighting clothing.

### SUMMARY OF THE INVENTION

The present invention is directed to a vertically stacked carded aramid web and a method of preparation wherein the web has a lengthwise rectangular cross-section with continuous parallel ridges and grooves of approximately equal spacing wherein said web comprises 5 to 95 parts by weight carded p-aramid fibers and 95 to 5 parts by weight carded m-aramid fibers, on a basis of 100 parts by weight of p-aramid and m-aramid fibers.

In a preferred embodiment the web comprises:

an area density in a range from 0.5 to 7 ounces per square yard,

a height of in a range from 2 mm to 50 mm and

a peak frequency which occurs in a range from 4 to 15 times per inch; and

0 to 20 parts by weight of binder.

A preferred use of the vertically stacked structure is as an inner lining in fire fighting clothing.

### BRIEF DESCRIPTION OF THE DRAWINGS

FIG. 1 is a block diagram illustrating the process for making new corrugated structures of the present invention.

FIG. 2A is a schematic view of a machine of the prior art which has two reciprocating elements which may be used with the process of the present invention for manufacturing the desired vertically stacked structures of the present invention.

FIG. 2B is a schematic view of the driving mechanism for the two reciprocating elements of the machine of the prior art shown in FIG. 2A.

FIG. 3 is a photographic representation of the vertically stacked structure of the present invention.

FIG. 4A is a perspective view of the vertically stacked structure of the present invention.

FIG. 4B is a cross-sectional view of an alternative embodiment of the vertically stacked structure of the present invention.

FIG. 4C is a cross-sectional view of a further alternative embodiment of the vertically stacked structure of the present invention.

FIG. 4D is a cross-sectional view of another alternative embodiment of the vertically stacked structure of the present invention.

FIG. 4E is a cross-sectional view of another alternative embodiment of the vertically stacked structure of the present invention.

FIG. 4F is a cross-sectional view of another alternative embodiment of the vertically stacked structure of the present invention.

FIG. 5 is a perspective view of a thermal liner employing the vertically stacked structure of the present invention.

FIG. 6 is a pictorial representation of a fire fighter's garment incorporating the vertically stacked structure of the present invention.

FIG. 7 is a sectional side elevation view of a composite fabric of the fire fighter's garment of FIG. 6.

### DETAILED DESCRIPTION OF THE INVENTION

Criticality is present in'the present invention is formation of a uniform vertically stacked carded aramid web by use of two different carded aramid fibers, namely a p-aramid fiber and a m-aramid fiber.

As employed herein the term aramid means polyamide wherein at least 85% of the amide (—CONH—) linkages are attached directly to two aromatic rings. Additives can be used with the aramid and, up to as much as 10 percent by weight of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the aramids most often used are: poly(paraphenylene terephthalamide) and poly(metaphenylene isophthalamide).

Two distinct embodiments of the present invention are present, namely (1) an embodiment which employs a combination of p-aramid and m-aramid fibers wherein the vertically stacked structure is held in a fixed position by use of binder material, and (2) an embodiment which employs a combination of p-aramid and m-aramid fibers wherein the vertically stacked structures are held in a fixed position by use of a supporting material on either one or both sides of the vertical stacking and vertically stacked structure is attached to the supporting material such as by stitching.

In both embodiments carded aramid fiber will be present in an amount of 5-95 parts by weight para-aramid and 95-5 parts by weight m-aramid (on a basis of 100 parts by weight). A preferred amount of aramid fibers will be 30 to 70 parts by weight p-aramid fibers and 70 to 30 parts by weight m-aramid fibers.

In the event a binder is present to hold the vertically stacked aramid in place it will generally be present in an amount of 1 to 20 parts by weight. Although higher amounts of binder can be present, an added amount is not considered necessary to impart a degree of rigidity to the vertically stacked structure. Lower amounts of binder will generally denote less rigidity. It is understood that the binder can be a fiber or can be employed, for example, as powder sprinkled on the web or structure or as a liquid applied to aramid fibers and subsequently solidified. The composition of the binder is not critical provided the binder imparts a degree of rigidity. A preferred class of binders are binders which are fixed in place by application of heat. It is understood that the binder will be selected on the basis of the final application of the vertically stacked structure. Illustratively, a lower melting binder is less desirable in a fire fighting article.

To provide structure consolidation, the feed blends comprise binder fibers having binder material that bonds at a temperature that is lower (i.e., has a softening point lower) than any (i.e., lower than the lowest) softening point of the said staple fibers in the feed blend, in the amount by weight about 1 to about 20 parts by weight of blend, the batt being heated in an oven to activate the binder material.

Sheath/core bicomponent fibers are preferred as binder fibers, especially bicomponent binder fibers having a core of polyester homopolymer and a sheath of copolyester that is a binder material, such as are commonly available from Unitika Co., Japan (e.g., sold as MELTY).

Useful classes of binders include polypropylene, polyethylene, polyester all of them either by themselves or as a combination in side-by-side or sheath/core bicomponent fiber configuration.

In the event a binder is not employed in conjunction with the vertically stacked structure then the vertical stackings are held in place by use of supporting structures such as a film or cloth on one or both sides of the vertical stacking. The supporting structures typically are physically connected to the vertical stackings such as by heat bonding, mechanical stress (pressure) or by stitching.

The type of supporting structures are not critical and will be selected in conjunction with known end uses of the vertically stacked structure. Examples of suitable support materials include thermal lining fabrics such as more fully illustrated below in a description of thermal liner fabrics.

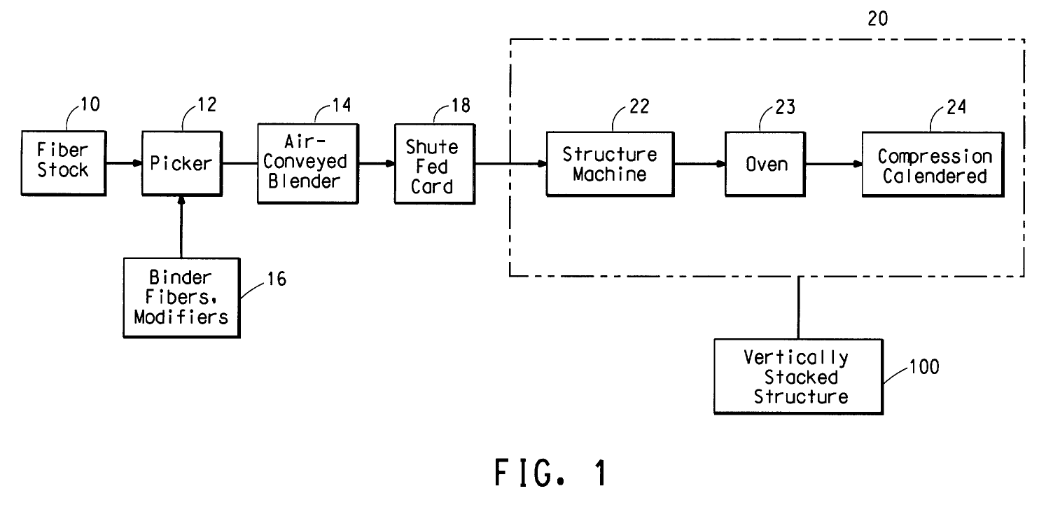

Referring to FIG. 1, a preferred embodiment of a process for forming a vertically stacked p-aramid/m-aramid fiber blend structure is illustrated. The process illustrated in FIG. 1 for making vertically stacked fibrous structures includes several steps. First, a fiber stock comprising a bale of p-aramid and a bale of m-aramid fiber material in raw form is presented. The fiber stock is shown at 10 in FIG. 1. These bales are tightly packed mass of staple fiber, weighing, for example, approximately 500 pounds (227 Kg).

Properties of the individual fibers (before being formed into structures) desirable to manufacture the final vertically stacked structure of the present invention include denier per filament and crimp frequency. Denier is defined as the weight in grams of 9000 meters of fiber and is thus a measure in effect of the thickness of the fiber which makes up the structure. Crimp of a fiber is exhibited by numerous peaks and valleys in the fiber. Crimp frequency is measured as the number of crimps per inch (cpi) or crimps per centimeter (cpcm) after the crimping of a tow. It has been found, through extensive testing, that fibers having a denier per filament of about 0.5 to about 10 (0.55-11 decitex per filament), cut length of about 0.5 to 4 inches (1.3 cm-10.2 cm) and crimps per inch of about 6 to about 15 (2.4 to 5.9 crimps per cm) are particularly useful for the vertically stacked structure of the present invention.

The fiber can be formed from para-aramids fibers sold under the trademark KEVLAR® by E.I. du Pont de Nemours and Company of Wilmington, Del. (hereinafter “DuPont”) and meta-aramid fibers sold under the trademark NOMEX® by DuPont.

Clumps of the fiber stock are removed one after another and then fed to a picker, which is shown at 12 in FIG. 1. At the picker, the fiber is opened up. A binder fiber is also sent to the picker as shown at 16 in FIG. 1, and the binder fiber is also opened up at the picker. Binder fibers of many different materials can be used, however, the preferred binder used is MELTY 4080 (commercially available from Unitika Co., Japan), which has a core of polyester homopolymer and a sheath of copolyester. Binder fibers are especially useful for improving the stability, dimensional and handling characteristics of the structure of the present invention, once it is formed. For example, if the blend of fibers and binder fibers is heated, during the heating step, the binder fibers melt and bond the fibers such that the vertically stacked structure of the present invention retains its desired configuration, i.e., specific height, peak frequency and area density, as will be discussed below. The structure may be stabilized without the use of a binder fiber but with a mechanical technique such as needle punching or thermal point bonding. Any modifier, such as a flame-retardant material, may also be added in addition to the binder fibers to obtain desired functional characteristics. It is also within the scope of the present invention to use a pre-blended fiber stock which already includes binder fibers, thereby eliminating the need for mixing the binder fibers in the picker.

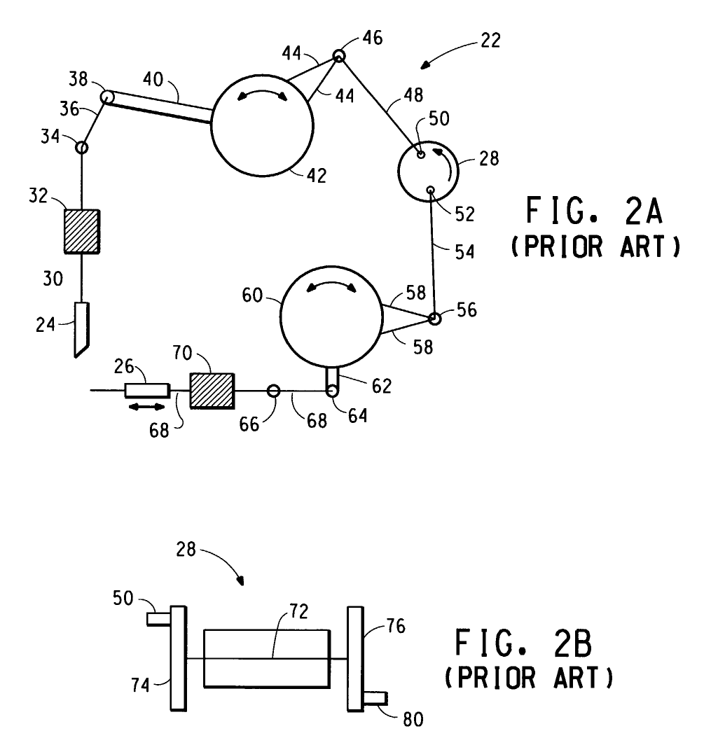

The process of the invention further comprises feeding the opened up fiber mixture/blend and the opened up binder fiber to a blender, such as air-conveyed blender 14 as shown in FIG. 1, to form a uniform mixture. The process of the present invention further comprises carding the blend to form a fibrous web. This carding is performed by a card as shown at 18 in FIG. 1 in order to form a fibrous web. The fibrous web is then sent, via a conveyer (not shown), into an Engineered Structure with Precision (ESP) machine 22 and an oven 23, the combination being shown generally at 20 in FIG. 1. The structure may be compressed or calendered 21 to achieve the desired height/thickness. Machine 22 is known in the art, as disclosed in WO 99/61693, and is shown in FIGS. 2A and 2B herein.

As shown in FIG. 2A, machine 22 includes two synchronously reciprocating elements 24 and 26 connected to a driving mechanism 28. A tie rod 30 connects element 24 to a sliding fitting 32 and also connects sliding element 32 to a flexible knuckle joint 34. Sliding fitting 32 keeps tie rod 30 in its vertical position. A bolt 38 connects tie rod 36 to an arm 40, which in turn is connected to a shaft 42. It is shaft 42 which imparts a vertical reciprocating motion to reciprocating element 24. A pair of tie rods 44 connect shaft 42 to driving mechanism 28 via a bolt 46 and a tie rod 48. Tie rod 48 is connected to driving mechanism 28 by a bolt, and a tie rod 54 is connected to driving mechanism 28 by a bolt 52. A bolt 56 connects tie rod 54 to a pair of tie rods 58, which connect to a shaft 60. Shaft 60 imparts horizontal reciprocating motion to reciprocating element 26. Shaft 60 connects to an arm 62, which is connected via flexible knuckle joints 64 and 66 and a tie rod 68 to a sliding fitting 70. The sliding fitting keeps the tie rod in its horizontal position.

As shown in FIG. 2B, driving mechanism 28 includes a driving shaft 72 with two cam rolls 74 and 76. Driving mechanism 28 reciprocates element 24 vertically and element 26 horizontally. The cam rolls allow synchronized phase movement of the reciprocating elements. Element 24 is reciprocated perpendicular to the lengthwise direction of the fibrous web, and element 26 is reciprocated parallel to the lengthwise direction of the fibrous web. These reciprocating motions thereby vertically fold the web to form a closely packed, vertically stacked structure and simultaneously move it forward (i.e., horizontally in the process direction away from the fibrous web).

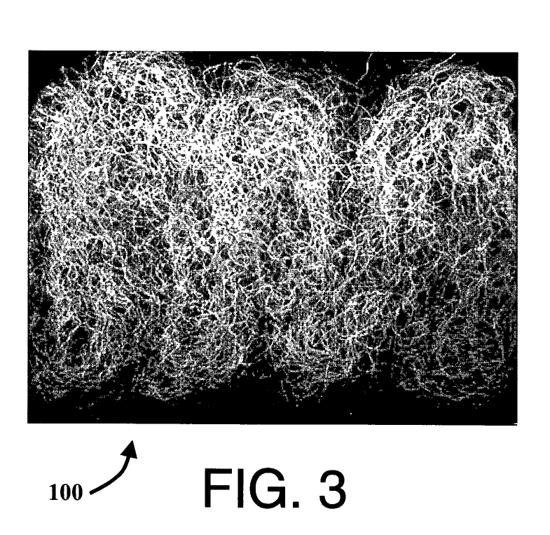

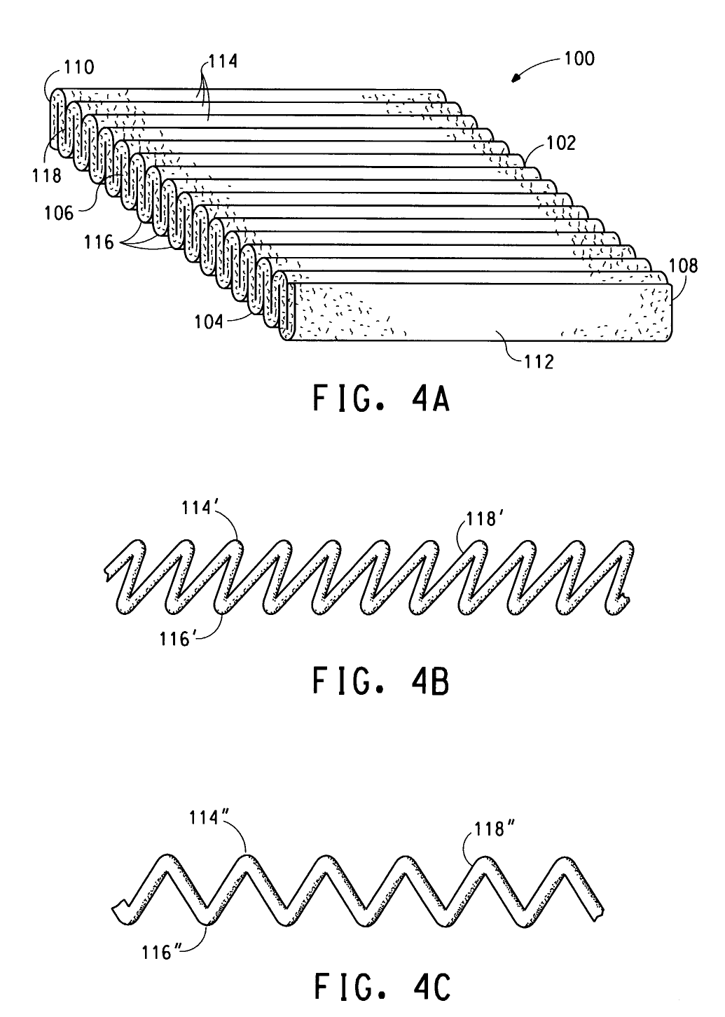

After the structure is shaped into its desired form, it is passed immediately into an oven, such as oven 23 as shown in FIG. 1, where it is heated to bond and consolidate it so that it maintains its vertical stackings. As the structure exits the oven, it is in the form of a folded structure. The resulting vertically stacked structure of the present invention is shown at 100 in FIGS. 3 and 4A. The bonded and consolidated structure may be compressed if desired to achieve the desired height/thickness.

Various configurations of the vertically stacked structure of the present invention are shown in FIGS. 4A-4F. As can be seen in these Figs., the vertically stacked structure of the present invention has an essentially lengthwise rectangular cross section. The vertically stacked structure as shown in FIG. 4A has an upper surface 102 and a lower surface 104, a side wall 106 and a side wall 108, and end walls 110 and 112. As can be seen from FIGS. 4A-4F, the vertically stacked structure comprises a plurality of continuous alternating peaks and valleys of approximately equal spacing. The peaks and valleys are shown at 114, 114′, 114″ and 114′″, 114″″ and 114′″″, and at 116, 116′, 116″, 116′″, 116″″ and 116′″″, respectively in FIGS. 4A-4F. In addition, the vertically stacked structure comprises a plurality of parallel aligned pleats, or vertical stackings, 118, 118′, 118″ and 118′″, 118″″ and 118′″″ which are arranged in accordion-like fashion and which extend in alternately different directions between each peak and each valley. The parallel aligned pleats may be interconnected by protruding fibers of the adjacent pleats. The upper surface of the structure is formed by the peaks, while the lower surface is formed by the valleys. The side walls 106, 108 are formed by the ends of the pleats, and the end walls 110 and 112 are formed by the last pleats of the structure. In the embodiments of FIGS. 4A-4C, E and F, the peaks and the valleys are generally rounded. The pleats of the vertically stacked structure can be saw-tooth, as shown in the embodiment of FIG. 4B, triangular shape, as shown in the embodiment of FIG. 4C, square/rectangular shape, as shown in the embodiment of FIG. 4D, “C” shaped as shown in the embodiment of FIG. 4E or “<” shaped as shown in the embodiment of FIG. 4F. Moreover, the vertical stacking may be vertical as shown in FIGS. 4A, 4C, 4D, 4E and 4F or inclined as shown in FIG. 4B.

Important features of the vertically stacked structure of the present invention, which have been predetermined by extensive testing, are area density, height and peak frequency. Specifically, the vertically stacked structure of the present invention has an area density of 0.5 to 7 oz/yd² preferably 2 to 4 oz/yd², a height of 2 mm to 50 mm, preferably 3 to 8 mm, and a peak frequency which occurs at 4 to 15 times per inch (1.58-5.91 times per cm) preferably 8 to 12 times per inch. The area density of the vertically stacked structure is controlled by fixing the throughput rate of the web and the output rate of the structure. The height of the vertically stacked structure is controlled by the thickness of a push bar (not shown) used for forcing the web away from reciprocating member 26 as shown in FIG. 2A and into the oven. Peak frequency is measured as the total number of peaks per inch (peaks per centimeter) of structure. For a given thickness of web, controlling the peak frequency is obtained by adjusting the speed of the reciprocating elements (i.e., the number of times per minute the reciprocating elements make contact with the fibrous web to form a crease (stratify)) and the speed of the conveyor belt which is used for moving the vertically stacked structure away from reciprocating member 24 in FIG. 2A. Further adjustment in structure height may be made by compressing the structure after it has been formed.

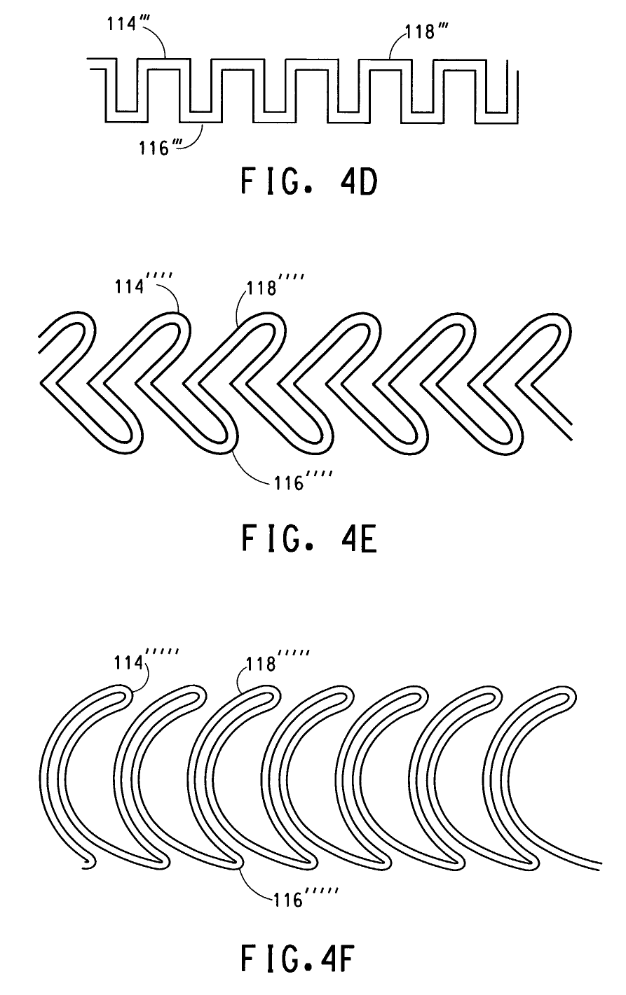

The protective fabric used as the heat insulating material, particularly as a thermal liner 11 (FIG. 5) in garments such as fire fighter's turnout suit, includes a face cloth of woven material 130 that has flame- and fire-resistant properties and an inner layer of spun-laced nonwoven material 120 that is thin and light and is thermally insulative. The face cloth is closest to the body while inner layer is away from the body. Sandwiched between the inner and face layers of material is an intermediate layer of material that is formed into a vertically stacked structure 100 comprising a plurality of continuous alternating peaks and valleys as previously discussed. The intermediate layer of vertically stacked structure holds the face and inner layers of the composite thermal liner apart.

While preferred materials have been suggested for the thermal liner fabric, it should be understood that the many layers that make up the thermal liner 11 including fabrics chosen from a wide range of possibilities. Material choices might, for example, be made from the group consisting of meta-aramid, other aramids, polynosic rayon, flame-resistant polynosic rayon, viscose rayon, flame-resistant viscose rayon, other flame-resistant cellulosics such as cotton or acetate, cotton, flame-resistant polyester, polybenzimidazole, polyvinyl alcohol, polytetrafluoroethylene, wool, flame-resistant wool, polyvinyl chloride, polyetheretherketone, polyetherimide, polyethersulfone, polychlal, polymide, polyamide, polyimide-amide, polyolefin, carbon, modacrylic, acrylic, melamine, and glass and blends made therefrom. Additional materials for use as face cloth 130 and the inner layer 120 include spun-laced knits, nonwovens, wovens, stitch-bonded fabrics and weft-insertion fabrics. Other suitable materials might also be selected consistent with the spirit and scope of the present invention depending upon the particular intended use of the fabric.

The face 130, intermediate 100, and inner 120 layers of material are securely bound together by lines of stitching 16 of a thermally resistant thread. The stitching extends through all three layers of the fabric and that preferably is configured in a quilted pattern defining contiguous regions 17 of the fabric 11. The tension applied to the stitching as it is sewn through the layers of material preferably is sufficient to collapse the pleated intermediate layer between the outer and inner layers along the lines of stitching as illustrated at 18. However, the stitching can be loose to avoid collapse of the intermediate layer and thus maintain maximum spacing between the inner and outer layers, if desired.

The stitching 16 functions to maintain the vertically stacked structure intermediate layer 100 securely in position between the face cloth 130 and inner layer 120 and thus preserves its deformed configurations by preventing the material of the intermediate layer from stretching out or bunching together as a garment is worn and washed. The quilted stitching pattern thus preserves the integrity of the pleats formed in the intermediate layer material so that the spacing between the face and inner layers and the air pockets defined therebetween are maintained throughout normal use and cleaning conditions. In this way, the fabric retains its performance qualities even after long use of a garment.

As mentioned briefly above, the material from which the inner and intermediate layers 120 and 100 are formed can be the same if desired with insulation qualities of its own. In this way, a wearer of a garment such as the turnout jacket of FIG. 5 having the fabric of this invention as a liner positioned adjacent the body of the wearer is insulated from heat and flame by the fabric.

A fire fighter's garment 34 incorporating the fabric of this invention is not only light and highly protective, it also tends to keep the fire fighter comfortable with a stretchable vertically stacked structure intermediate layer 100 while fighting a fire.

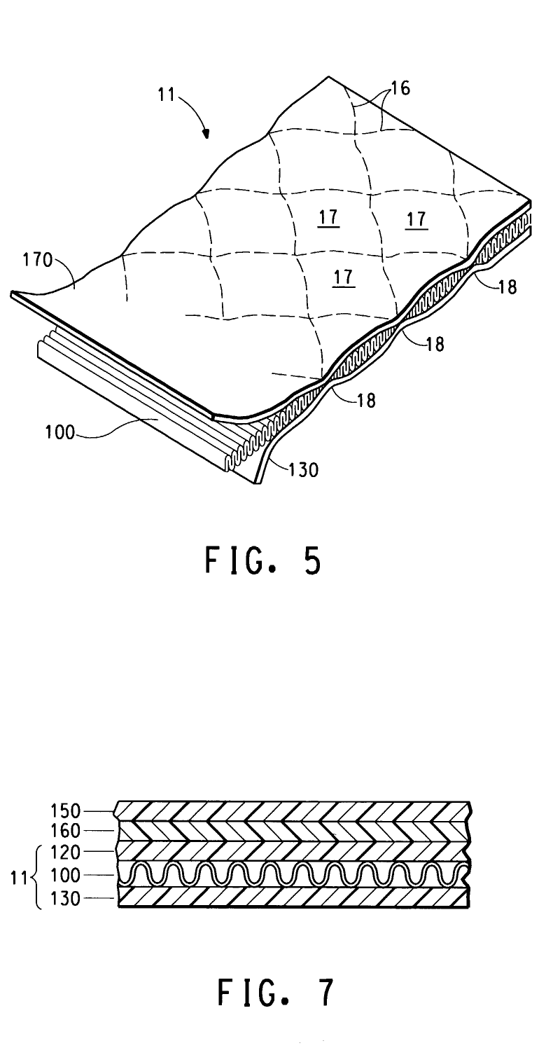

FIG. 6 illustrates a fire fighter's protective garment that incorporates the vertically stacked structure of this invention as an interior thermal liner or barrier. The illustrated garment is comprised of a protective coat 34 having a trunk portion 36, sleeves 37, and collar 38. The outer shell 150 of the coat 34 can be formed of a number of flame and abrasion-resistant materials such as woven aramid or polybenzimidazole fabrics commonly used in the construction of such garments. The moisture barrier material 160 is next in from the outer shell 150 and the thermal inner liner 11 is next. These layers of fabric are bound together at the edges of the garment.

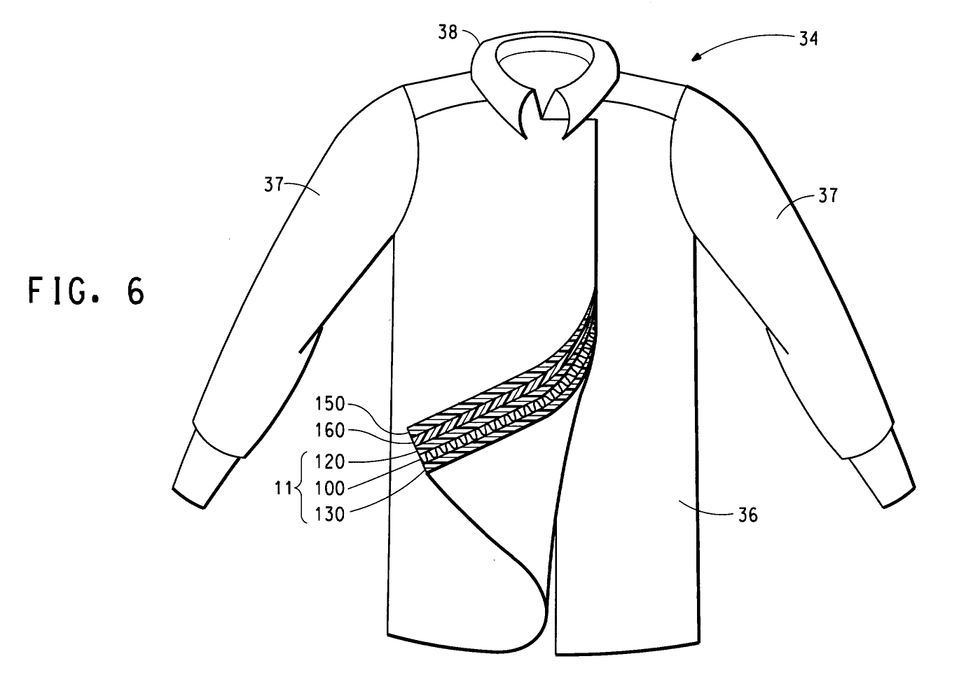

FIG. 7 is an enlarged sectional side elevation view of the composite fabric used in fire fighter's turnout suit 34 of FIG. 6 showing the special configuration and interrelationships of the various layers of the fabric. The turnout suit typically comprises an outer shell fabric 150 that is heat- and abrasive-resistant, a moisture barrier 160 as the next layer and a thermal liner 11.

The vertically stacked structure of the present invention can also be used to make other articles, such as sleeping bags, cushion seats, insulated garments, filter media, insulating curtains, flame blockers, wall coverings, etc. These articles have the desired characteristics obtained by determining the desired area density, height and peak frequency of vertically stacked structure used. For any article made with the vertically stacked structure of the present invention, either a single layer or plural layers of structure may be used, depending on the desired properties of the final article.

To further illustrate the present invention, the following examples are provided. All parts and percentages are by weight unless otherwise indicated.

### EXAMPLE 1

Clumps of the fiber stock, consisting of three components, are removed one after another and then fed to a picker. The three components are (i) Kevlar® Type 970 (2.25 dpf, 1.5 inch cut length,) (ii) Nomex® Type 40 (1.5 dpf, 1.5 inch cut length), and (iii) Unitika binder fiber MELTY 4080 Type S74 (4.0 dpf, 1 inch cut length). The relative concentration by weight is 45% Kevlar® p-aramid, 45% Nomex® m-aramid and 10% binder fiber. The opened-up fiber mixture was well blended in an air-conveyed blender to form a uniform mixture. The well blended fiber mixture was carded to form a fibrous web. Carding machine operating at input speed of 1.5 feet per minute while the card doffer was operating at a speed of 49.2 feet per minute. The well blended, uniform card web was then converted into the vertically stacked structure comprising a plurality of continuous alternating peaks and valleys of the present invention. The accordion-like arrangement of the structure which extends in alternately different directions between each peak and each valley was formed by the driving mechanism reciprocating element, moving up and down vertically at a frequency of 300 revolutions per minute. The vertically folded structure immediately entered into an oven at a speed of 3.7 feet per minute. The oven was maintained at 400° F. to bond and consolidate the structure to maintain its vertical stacking. The structure height was 10 mm, with an area density of 102 g/m² and a peak frequency of 10 peaks/inch. The structure height was subsequently reduced to 5 mm by applying pressure and heat.

The thermal protective performance (TPP) test used for quantifying a fireman's turnout garment was measured on a composite sample consisting of three major components—outer shell, moisture barrier and thermal liner. The outer shell used was a 7.0-8.0 oz/yd² (nominal 7.5) woven fabric made of Kevlar® fiber (60%) and PBI fiber (40%). The moisture barrier fabric was 4.0-5.0 oz/yd² (nominal 4.5) Crosstech® fabric, a PTFE laminated to fabric of Nomex® brand fiber. The thermal liner consisted of the vertically stacked structure sandwiched (inserted) between a layer of 1.5 oz/yd², Nomex® liner E-89, spunlaced fabric and a 2.0-2.5 (nominal 2.2) inner face fabric of woven Nomex® fiber as the inside of the garment. The total composite weight of the assembly was 18.8 oz/yd². The composite assembly was tested for TPP with the outer shell exposed to the heat source per procedure described in NFPA-1971. The TPP obtained was 46.3 Cal/cm².

The control consisted of an identical outer shell, a moisture barrier and the woven Nomex® inner facing fabric. The commonly used commercial thermal insulation consisted of three layers of Nomex® E-89 brand spunlaced fabric. Assembled with these components, this thermal insulation resulted in a TPP of 42.0 at a measured assembly weight of 20.3 oz/yd².

### EXAMPLE 2

Vertically folded structures were made substantially the same as in Example 1 except with varying height, peak frequency and area density, shown in Table 1. They were sandwiched between the spunlaced fabric and face cloth and then added to a outer shell and moisture barrier to form a composite. The only variable was the vertically folded structure properties of the thermal liner assembly.

### EXAMPLE 3

Thermal liner inserts sandwiched between the spunlaced fabric and the face cloth were made consisting of a carded web which had been cross-lapped. This was obtained by blending a 45% Nomex® fiber, 45% Kevlar® fiber and 10% binder fiber Type MELTY S74 in a Rando blender. The well blended fibers were sent to a master chute-fed card. The web from the card was cross-lapped and sent to an oven. The oven was maintained at preheat 424° C. and heat zone 330° F. The thruput rate was 12 feet/minute. A composite structure was formed essentially as described in Example 1 with a weight of 19.3 oz/yd². The resulting TPP was 45.0 Cal/cm².

| | | | Peak Freq | Compressed | Composite | | |
|---|---|---|---|---|---|---|---|
| | Thickness | Area Den | (peaks | Thickness* | Weight | TPP | Thickness |
| Item | (mm) | (g/m2) | per in) | (mm) | (oz/yd2) | (cal/cm2) | (mil) |
| 2-1 | 10 | 68 | 6.1 | | 18 | 42.9 | 517 |
| 2-2 | 10 | 102 | 8.6 | | 18.6 | 44.5 | 536 |
| 2-3 | 10 | 136 | 10.9 | | 19.2 | 48.4 | 582 |
| 2-4 | 10 | 170 | 13.8 | | 20.5 | 57.9 | 665 |
| 2-5 | 10 | 204 | 16.7 | | 21.6 | 62.1 | 658 |
| 2-6 | 10 | 237 | 21.1 | | 22.5 | 70.1 | 692 |
| 2-7 | 15 | 102 | 8.6 | | 18.8 | 46.6 | 635 |
| 2-8 | 20 | 102 | 8.6 | | 19.2 | 48.2 | 805 |
| 2-1 | | | | 9.7 | 17.35 | 40.57 | 323 |
| 2-2 | | | | 7.11 | 18.32 | 43.89 | 267 |
| 2-3 | | | | 8.33 | 19.2 | 47.32 | 337 |
| 2-4 | | | | 7.56 | 19.84 | 51.19 | 300 |
| 2-5 | | | | 7.16 | 20.45 | 53.3 | 261 |
| 2-6 | | | | 5.58 | 21.58 | 58.74 | 263 |
| 2-7 | | | | 3.96 | 18.64 | 46.89 | 183 |
| 2-8 | | | | 7.62 | 18.87 | 48.2 | 231 |

Kevlac ® Type 970, 2.25 dpf, 1.5 inch Cut-45%
Nomex ® Type 450, 1.5 dpf, 1.5 inch cut-45%
Unitika Binder Type S74, 4.0 dpf, 1.0 inch cut-10%
Den means density
Freq means frequency

What is claimed is:

1. A vertically stacked carded aramid web having a lengthwise rectangular cross-section with continuous parallel ridges and grooves of approximately equal spacing wherein said web comprises 5 to 95 parts by weight carded p-aramid fibers and 95 to 5 parts by weight carded m-aramid fibers, on a basis of 100 parts by weight of p-aramid and m-aramid fibers.

2. The web of claim 1 with an area density in a range from 0.5 to 7 ounces per square yard,
a height of in a range from 2 mm to 50 mm and
a peak frequency which occurs in a range from 4 to 15 times per inch and
0 to 20 parts by weight of binder.

3. The web of claim 2 wherein binder is present.

4. The web of claim 2 wherein binder is not present and vertical stacking in the web are fixed by attachment to supporting structures on either one or both sides of the web.

5. The web of claim 4 wherein the web is physically attached to the supporting structure.

6. The web of claim 2 wherein:
the area density is in a range from 2 to 4 ounces per square yard,
the height is in a range from 3 to 8 mm and
the peak frequencies is in a range from 8 to 12 times per inch.

7. The web of claim 1 wherein the p-aramid fibers are present in an amount of 30 to 70 parts by weight and the m-aramid fibers are present in an amount of 70 to 30 parts by weight.

8. The web of claim 1 present in an article of heat insulation and fire fighting clothing.

9. A method for forming a vertically stacked carded aramid web comprising:
feeding clumps of p-aramid and m-aramid fibers and binder fibers to a picker where the fibers are opened up;
feeding the opened up fibers to a blender to form a fibrous web;
carding the blend to form a fibrous web;
vertically folding the fibrous web to form a vertically stacked structure having a lengthwise rectangular cross-section with continuous alternating peaks and valleys of approximately equal spacing, and a plurality of vertically aligned pleats which extend between each peak and valley; and
heating the vertically stacked structure to bond the binder fibers and the aramid fibers so that the structure is consolidated and maintains its vertical stackings, wherein the web comprises 5 to 95 parts by weight carded p-aramid fibers and 95 to 5 parts by weight carded m-aramid fibers, on a basis of 100 parts by weight of p-aramid and m-aramid fibers.

10. The method of claim 9 wherein the web has an area density in a range from 0.5 to 7 ounces per square yard,
a height of in a range from 2 mm to 50 mm and
a peak frequency which occurs in a range from 4 to 15 times per inch.

11. The method of claim 10 wherein the web comprises 1 to 20 parts by weight of binder.

12. The web of claim 1 present in a fire fighting clothing.
